(19) United States
(12) Patent Application Publication
(10) Pub. No.: US 2003/0232160 A1
(43) Pub. Date: Dec. 18, 2003

(54) Method and apparatus for forming a bent or folded edge rim of a self-supporting thin-walled molded component

(75) Inventor: Ernst Maximilian Spengler, Heusenstamm (DE)

Correspondence Address: FASSE PATENT ATTORNEYS, P.A., P.O. BOX 726, HAMPDEN, ME, 04444-0726, US

(73) Assignee: R + S TECHNIK GMBH, Offenbach am Main (DE)

(21) Appl. No.: 10/465,701

(22) Filed: Jun. 18, 2003

(30) Foreign Application Priority Data
Jun. 18, 2002 (CZ) PV 2002 - 2129

(51) Int. Cl. B32B 1/02

(52) U.S. Cl. 428/34.1; 264/295; 425/319; 425/391

(57) ABSTRACT

An apparatus includes several bending units for forming a singly-bent or doubly-folded edge rim around the perimeter of a molded component, e.g. a laminated contoured interior trim component for a motor vehicle. Each bending unit includes an electrically heatable cutting or impressing tool, and a bending tool. A workpiece holder clamps the component into a forming mold. The heated impressing tool melts and presses one or two grooves forming weakened zones and corresponding bending lines in the edge rim of the component. The bending tool then presses and bends the edge rim flange back along the bending line. Optionally, the bending tool additionally bends the free edge flange portion down along the second bending line to form the doubly-folded rim. The portions of the rim folded against each other are melt-bonded together and then cooled to permanently fix the bonded and folded configuration of the rim.

### PRIORITY CLAIM

This application is based on and claims the priority under 35 U.S.C. §119 of Czechoslovakian Patent Application PV 2002-2129, filed on Jun. 18, 2002, the entire disclosure of which is incorporated herein by reference.

### FIELD OF THE INVENTION

The invention relates to a method and an apparatus for forming the free edge rim of a self-supporting, thin-walled molded component, such as a laminated and molded interior trim component for a motor vehicle. The edge rim is formed by bending, folding, and/or beading an edge rim flange of a raw or unfinished blank for the molded component.

### BACKGROUND INFORMATION

Methods and apparatuses of the general type pertinent to the present invention are commonly known in a variety of different forms and embodiments. For example, the German Utility Model Publication DE 94 07 177 U1 discloses an apparatus that uses an electrical current and high frequency for achieving a heating effect, by means of which a binder or adhesive is activated for adhesively bonding or gluing beaded or folded edge rim flanges on a base member. The bending or folding of the edge rim flanges has been previously carried out in a mechanical manner.

The use of high frequency electrodes for activating an adhesive or binder for fixing mechanically bent or folded edge rim flanges is also known from the German Patent Publication DE 35 22 878 A1.

It is also known to use heat lamps or radiators that are directed onto the back side of the molded component, for heating the same. For example, such a heating arrangement is disclosed in German Patent Publication DE 94 20 596, in which the actual bending or folding of the edge rim flanges is carried out using a generally known bending guide straightedge.

In the fabrication of multi-layered laminated molded components containing thermoplastic synthetic polymer materials, such as polyester fibers for example, it is also known to use the inherent melting-adhesion of the materials for fixing or bonding the edge rim parts without using an additional adhesive. For example, according to the German Utility Model Publication DE 295 07 067 U1, an edge rim part that has been bent over and is to be bonded or fixed, for this purpose is heated, for example with hot air, to achieve a self-bonding thereof. Alternatively, such an edge rim is additionally provided with an adhesive to adhesively bond the mechanically folded-over edge rim parts thereof according to the German Patent Publication DE 40 41 934 A1.

The above described methods and apparatuses suffer many different disadvantages and shortcomings. For example, the known methods and apparatuses operate with a high energy consumption. Also, whenever edge rim parts are pressed together during the edge folding or beading process, there is always the danger of the undesired result, that the finished free edge rim of the finished molded component will be very stiff due to the doubling, folding, and compaction of the material at the area of the fold. Also for this reason, large bending radii of the folded areas are typically necessary. Furthermore, in the known methods and apparatuses, the selection of useable decorative cover stock materials is often quite limited, due to the particularities of the known methods and apparatuses. For example, cover stock materials with a particular surface texture or the like are not suitable, because the surface texture will be destroyed, damaged, or interfered with during the edge folding and pressing operations. Also, the finished quality of the folded or beaded and pressed edge rims is often unsatisfactory, for example, due to the bunching, compaction, and/or doubling of the folded material along the folded edge of the finished edge rim.

### SUMMARY OF THE INVENTION

In view of the above, it is an object of the invention to provide a method and an apparatus with which it is possible to bend or fold the edge rim flanges of molded component raw blanks in such a manner so as to achieve a high finished quality while avoiding the conventionally occurring defects, and allowing the edge rim to be bent, folded or beaded along the entire edge contour of the molded component. The invention further aims to avoid or overcome the disadvantages of the prior art, and to achieve additional advantages, as apparent from the present specification.

The above objects have been achieved in a method, an apparatus, and a molded component according to the invention, according to which the cross-sectional thickness of the material of the raw or unfinished blank for the molded component is first reduced to form a linear or curved line-form groove, trough, recess, or fold line with the aid of applied heat along an area close to and extending along the edge of the raw blank. This forms an edge rim flange that is connected through the groove-shaped weakened zone or bending line to the body of the raw blank. Then, the edge rim flange is mechanically bent or folded along this groove-shaped bending line, and is then finally fixed in the bent or folded configuration by cooling, i.e. by removing the previously applied heat.

The formation of the groove-shaped weakened zone or bending line simultaneously achieves several advantages. First, the removal of material along this bending line to form the groove avoids the bunching, compaction, and/or doubling of the material along the fold line or bend line in the finished configuration. Also, the groove-shaped fold line or bending line provides a weakened zone that facilitates the bending or folding operation, and establishes a precise line along which the fold or bend is to take place. Furthermore, the heating of the material followed by the folding or bending and then the cooling thereof achieves the self-adhesive melt-bonding of the material, and thus avoids the need of an additional adhesive along the fold or bend line.

According to the invention, the bending, folding, and/or beading of edge rim parts or flanges of nearly finished or semi-finished molded components or unfinished or raw blanks for molded components, for producing precise edge rims with a visually defect-free appearance, is carried out in a mold that receives the raw or unfinished blank for the molded component. The unfinished blank may be a raw unfolded pre-cut piece of material, or may have been previously molded to achieve the desired three-dimensional contour, and simply needs the edge rim to be formed, in order to finish the molded component. In the mold, the unfinished blank is first held in an exact position by a movable workpiece holder.

Then, the above-mentioned line-shaped or groove-shaped weakened zone is formed (or plural such zones are formed respectively) as a bending line acting as an integral film hinge in the material of the unfinished blank, so as to form a bendable or foldable protruding edge rim flange that will then be bent or folded over. This weakened zone is preferably formed using one or more electrically heatable impressing or stamping electrodes, which are pressed against or into the material of the unfinished blank at the area of the intended weakened zone, in order to remove, melt away, displace, or melt and compress or densify material of the unfinished blank along this linear or curved area, so as to form a channel or groove, for example having a wedge-shaped cross-section, along this weakened zone.

The resulting strip-shaped edge rim flange between the weakened zone and the edge of the unfinished blank is then pushed and thereby bent or folded or beaded into its end position in a mechanical manner using at least one pressing or bending tool. Thereby, the opposite bounding surfaces of the respective weakened channel or groove come into contact with each other, while the channel or groove itself is pressed closed, and the two opposite bounding surfaces are melt-bonded to each other due to their sufficiently elevated temperature and at least partially melted condition. Then, heat is removed from the bent or folded edge rim area, i.e. this area is cooled, so as to solidify and fix the edge rim flange or flanges in the final bent, folded or beaded position.

Further according to the invention it is possible to form not only one, but two linear or curved weakened zones running parallel to each other adjacent to and along the edge of the unfinished blank, thereby forming not only one, but two edge rim flanges (e.g. an outer free edge flange and an intermediate strip) that extend parallel to each other along the rim of the unfinished blank for the molded component. This is achieved simply by using two parallel impressing or stamping electrodes rather than a single impressing or stamping electrode. Both of the strip-shaped edge rim flanges may then, for example, be bent or folded by 90° relative to the adjacent part, and then may be fixed in this position. As a result, the finished, folded or beaded edge rim includes two 90° bends, i.e. whereby the outer or free edge rim flange along the actual edge of the unfinished blank is folded back by 180°. The actual finished rim at the edge of the finished molded component is formed by the first or intermediate edge rim flange (i.e. the intermediate strip), which is bent by 90° relative to the adjoining portion of the body of the unfinished blank for the molded component. dr

### BRIEF DESCRIPTION OF THE DRAWINGS

In order that the invention may be clearly understood, it will now be described in detail in connection with example embodiments, with reference to the accompanying drawings, wherein:

FIG. 1 is a schematic top plan view of an apparatus for bending, folding, and/or beading edge rims of an unfinished blank for a molded component;

FIG. 2 is a schematic plan view of a part of the apparatus of FIG. 1, particularly showing a fabrication mold and movable workpiece holders for holding or fixing the unfinished blank during the edge folding process;

FIG. 3 is an enlarged partial side view of the essential parts of a single edge folding or bending unit of the apparatus for carrying out the edge rim folding or bending process;

FIG. 4 is a view similar to that of FIG. 3, but showing a successive process step;

FIG. 5 is a view similar to that of FIG. 4, but showing a further successive process step;

FIG. 6 is a view similar to that of FIG. 5, but showing a further successive process step;

FIG. 7 is a view similar to that of FIG. 6, but showing a further successive process step;

FIG. 8 is a view similar to that of FIG. 7, but showing a further successive process step;

FIG. 9 is a view similar to that of FIG. 8, but showing a further successive process step;

FIG. 10 is a view similar to that of FIG. 9, but showing a further successive process step;

FIG. 11 is a view similar to that of FIG. 10, but showing a further successive process step;

FIG. 12A is an enlarged schematic side view showing the cooperation of a rim-bending tool in the form of a slider and a countertool formed by the free rim surface of the mold, for folding or bending the edge rim of the unfinished blank;

FIG. 12B is a view similar to that of FIG. 12A, but additionally shows an impressing or stamping tool that forms two weakened bending lines, in cooperation with the components shown in FIG. 12A;

FIG. 12C is a view similar to that of FIG. 12A, but showing a further process step subsequent to the step of FIG. 12B;

FIG. 12D is a view similar to that of FIG. 12C, but showing a further successive process step;

FIG. 13A is an enlarged schematic side view generally similar to that of FIG. 12A, but showing a different rim-bending tool in the form of a slider cooperating with a countertool provided by the free rim surface of the mold;

FIG. 13B is a view similar to that of FIG. 13A, but additionally shows an impressing or stamping tool for forming a single weakened bending line in cooperation with the components of FIG. 13A;

FIG. 13C is a view similar to that of FIG. 13B, but shows a subsequent process step following that of FIG. 13B;

FIG. 14 is an enlarged schematic side view of the impressing or stamping tool according to FIG. 13B;

FIG. 15 is an enlarged schematic side view of the impressing or stamping tool according to FIG. 12B;

FIG. 16 is an enlarged schematic side view of the rim-bending tool according to FIGS. 13A, 13B and 13C; and

FIG. 17 is a schematic partial perspective view of an unfinished blank for a molded component with a notched arcuate rim flange before the rim folding or bending process.

### DETAILED DESCRIPTION OF PREFERRED EXAMPLE EMBODIMENTS AND OF THE BEST MODE OF THE INVENTION

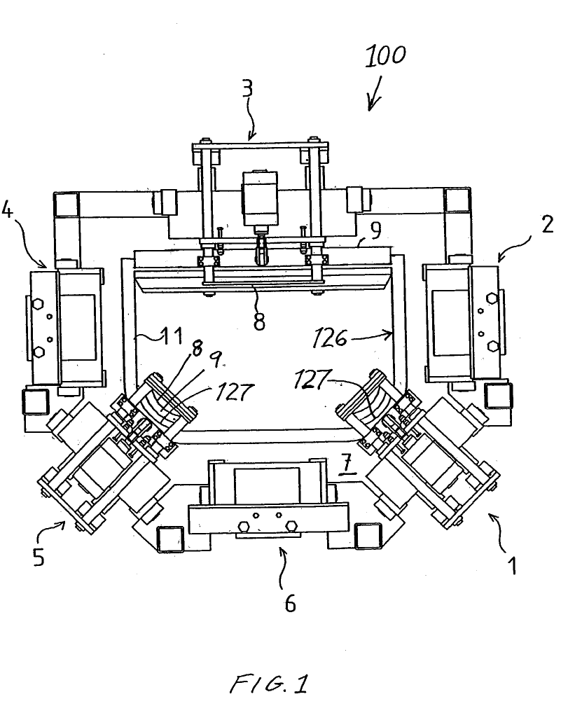

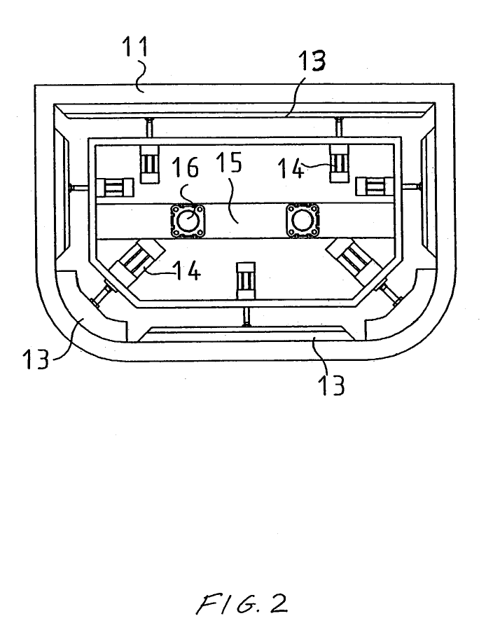

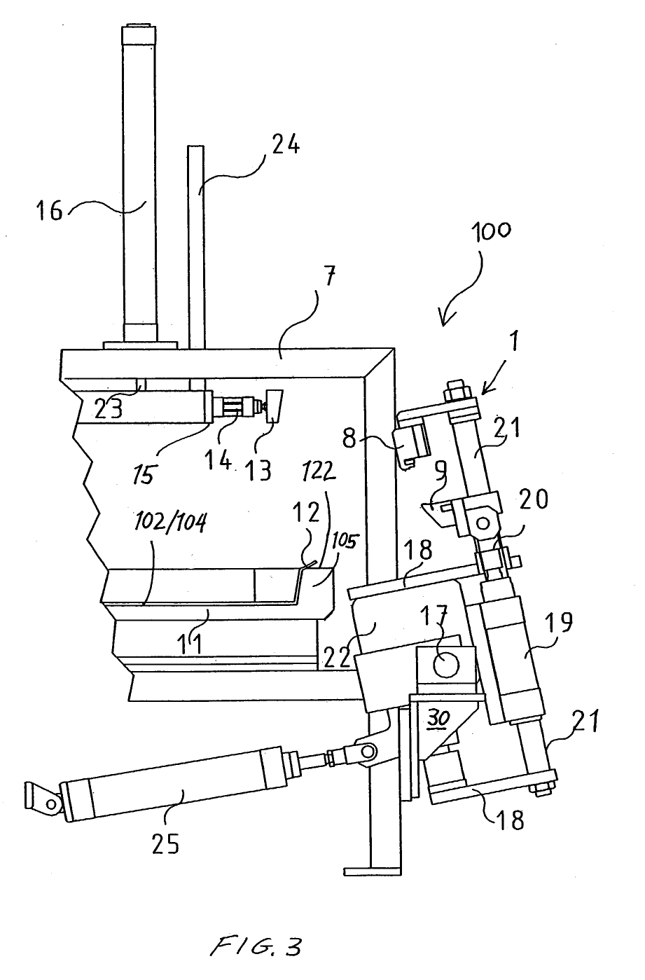

As generally schematically shown in FIG. 1, an apparatus 100 is provided for bending or folding an edge rim of a self-supporting thin-walled molded component. Herein, the term “self-supporting” means that the finished molded component generally maintains its molded shape and supports itself if it is secured at suitable locations, while still allowing for some flexibility and the like, and the term “thin-walled” means that the finished molded component has area dimensions that are much larger than (e.g. at least 10 or even at least 20 or 50 times) the thickness dimension thereof, as is typical of molded interior trim components for motor vehicles in this field. The apparatus 100 comprises six rim bending units 1, 2, 3, 4, 5, and 6 successively arranged around the perimeter of the outline or contour of the molded component. The bending units 1 to 6 are mounted and movably arranged in a machine frame 7. The apparatus further includes a mold 11 that carries and supports an unfinished blank 102 or 104 that will form the molded component. The mold 11 is also mounted and arranged in the machine frame 7. In the rest position, the bending units 1 to 6 are located outwardly around the mold 11 as shown in FIG. 3.

While the illustrated example embodiment involves a plurality of bending units 1 to 6 in the apparatus 100, it should be understood that the inventive method and apparatus could instead involve only a single bending unit. In any event, whenever two or more bending units are provided, adjacent ones of the bending units are operated in an alternating manner, or correspondingly in suitable groups, so that the respective operation of the several bending units does not interfere with each other.

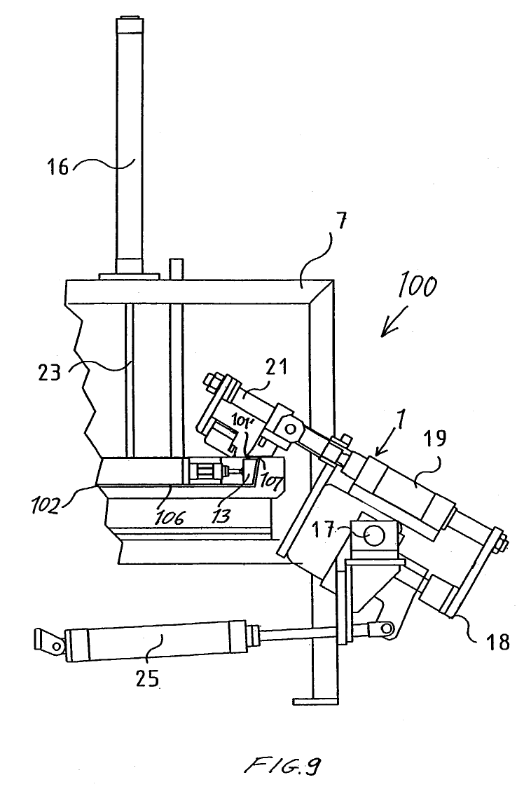

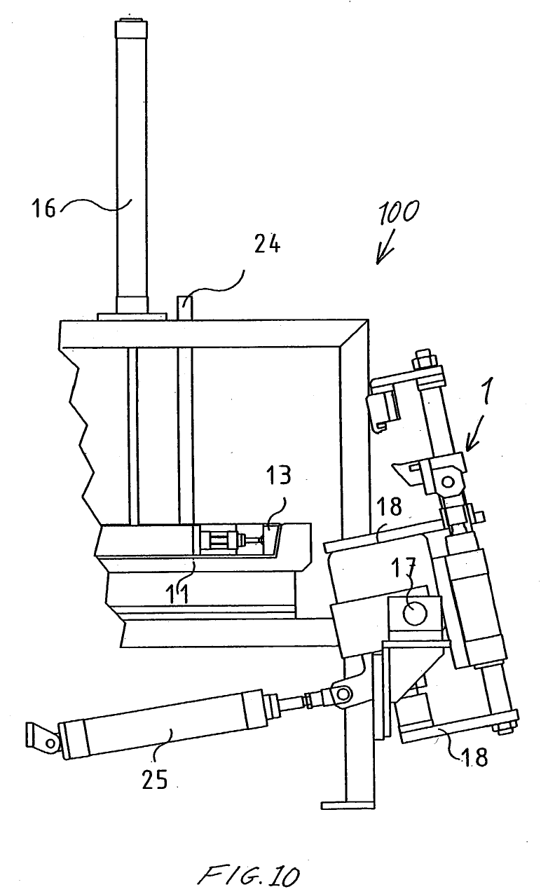

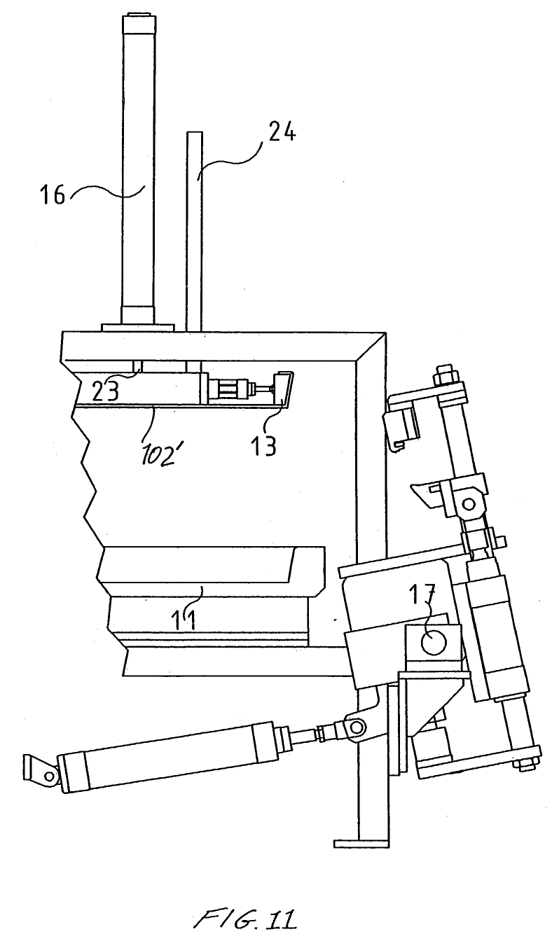

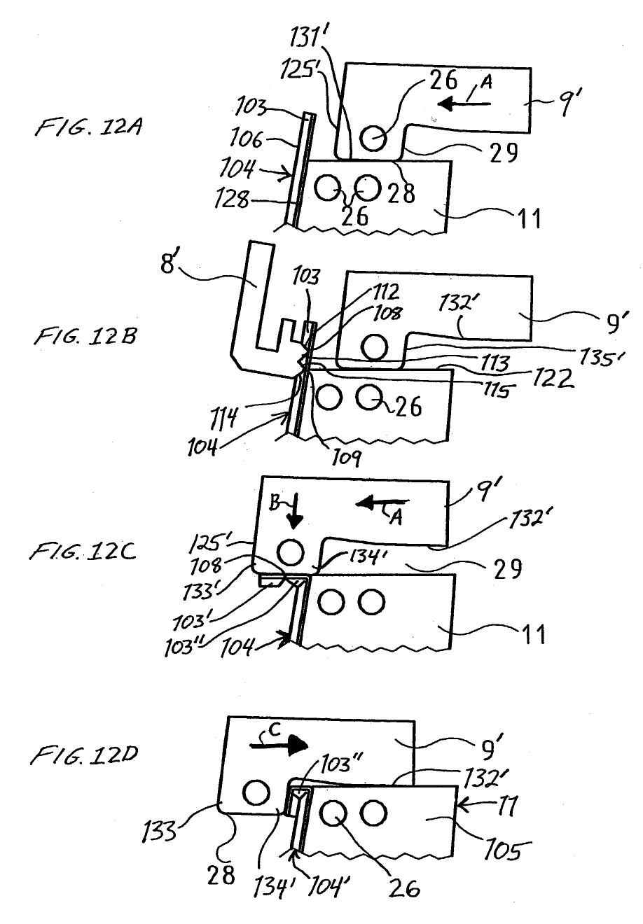

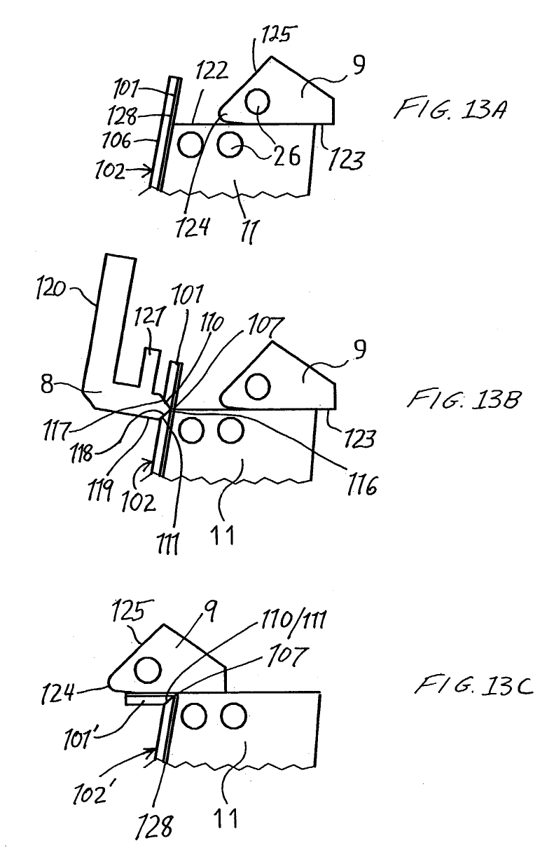

Each bending unit 1 to 6 includes a heatable impressing or stamping element 8 and a pressing or rim bending element 9. The rim 105 of the mold 11, against which the molded component unfinished blank 102 or 104 rests and is supported during the edge rim forming process, simultaneously serves as a countertool for the heatable impressing or stamping elements 8 and for the pressing or rim-bending elements 9 of the bending units 1 to 6. The tools 8 and 9 will serve to form the singly-bent edge rim 101′ of the molded component 102′ (as shown in FIG. 13C) or the doubly-folded or beaded edge rim 103′″ of the molded component 104′ (as shown in FIG. 12D) as will be discussed in detail below.

Namely, the apparatus 100 can generally be used for bending or angling a bent or angled edge rim flange 101 of a molded component unfinished blank 102 according to the example embodiment shown in FIGS. 13A, 13B and 13C (as will be discussed below), or for folding over or beading an edge rim flange 103 of a molded component unfinished blank 104 according to the example embodiment shown in FIGS. 12A, 12B, 12C and 12D (as will be discussed below). In the former or first mentioned example embodiment, the molded component 102′ (FIG. 13C) comprises an angled or bent rim 101′ with a single bent edge rim flange 101, while the latter or second above-mentioned example embodiment involves a molded component 104′ (FIG. 12D) with a folded-over or beaded edge rim 103′″ consisting of two folded-over strip-shaped edge rim flange portions 103′ and 103″ (FIG. 12C).

In order to form or process the edge rim 12 of a molded component unfinished blank 102 or 104, the unfinished blank 102 or 104 is first placed into the forming mold 11 and then fixed in the proper registered position with the aid of one or more movable workpiece holders or counterholding tools 13 (as shown in FIGS. 3 to 5). In this example embodiment, as shown in FIG. 3, the workpiece holder 13 is connected to and driven by a first horizontal drive 14 and a second vertical drive 16. Both of these drives 14 and 16 are preferably pneumatic piston-cylinder drives. These drives serve to lower the workpiece holder 13 into position in the mold cavity of the forming mold 11, and then to press or clamp the workpiece holder 13 against a sidewall or rim 105 of the forming mold 11 so as to hold the unfinished blank 102 or 104, as follows. The vertical drive 16 includes a piston rod 23 that is connected to and selectively raises or lowers a carrier frame 15. The horizontal drive or drives 14, in turn, are mounted on and carried by the carrier frame 15, and the drive or drives 14 in turn directly horizontally move the workpiece holder or holders 13. Furthermore, at least one vertical guide rod 24 is provided for guiding the vertical motion of the carrier frame 15.

Each one of the bending units 1 to 6 respectively incorporates a complete set of all the tools or other machine components that are necessary for bending, folding, and/or flange-beading the edge rim of the unfinished blank, namely including the movable and heatable impressing or stamping element 8 as well as the movable pressing or rim-bending element 9, and their respective drives. As an example, the bending unit 1 is shown and described in detail in connection with FIGS. 3 to 11.

The integrated bending unit 1 is pivotally connected to the machine frame 7 of the apparatus 100 by a mounting bracket 30, so that the entire bending unit 1 is pivotable about the pivot axle or axis 17. A pivot drive 25, for example embodied as a piston-cylinder device, is connected at one end to the machine frame 7 and at the other end to a carrier 31 of the bending unit 1, that sits pivotally directly on the axle 17. With this arrangement, the pivot drive 25 serves to selectively pivot the entire bending unit 1 about the pivot axle 17 relative to the machine frame 7.

Furthermore, a linear drive 19 for moving the pressing or rim-bending element 9 and a linear drive 22 for moving the heatable impressing or stamping element 8 are arranged on the carrier 31. Both of these linear drives 19 and 22 are suitably pneumatic drives, such as pneumatic piston cylinder devices or pneumatic bellows drives or the like.

A piston rod 20 of the linear drive 19 is connected to the pressing or rim-bending element 9 so as to directly act on and move the element 9. This is directly visible in the views of FIGS. 3 to 11. On the other hand, the other linear drive 22 in this example embodiment is effective in a different plane than the linear drive 19, and particularly a plane behind the plane of the linear drive 19 in the view of FIGS. 3 to 11. Since the heatable element 8 is arranged and acts in the same plane as the pressing element 9, this also means that the linear drive 22 provides a force transmission or force coupling through a different plane to the heatable element 8. Particularly in this context, the linear drive 22 first acts directly on a connector element 32 in the manner of a piston rod or push rod, which in turn acts on a connector bracket or element 18 that is connected perpendicularly to the push rod connector element 32. This second connector bracket or element 18 can, for example, be in the form of a plate-shaped bracket. From there, two thrust rods or push rods 21 are arranged parallel to each other and spaced apart from each other, so as to be slidable in the bending unit 1. Particularly, the lower end 33 of each one of the push rods 21 is secured to the plate-shaped connector bracket 18. From there, the two push rods 21 extend upwardly on opposite sides of the linear drive 19, up to the upper ends 34 of the push rods 21, on which the heatable element 8 is carried. Particularly, the heatable element 8 is secured by a spacer bracket 35 on the upper ends 34 of the push rods 21.

It should further be understood, as can be seen also in FIG. 1, that both the heatable element 8 as well as the pressing element 9 have a generally elongated shape and configuration, which generally extends along a corresponding portion of the edge contour of the edge rim of the unfinished blank that is to be processed to form the finished molded component. This contour can be a straight line, or any shape of curve, as desired for the finished rim of the molded component.

The functions and the operating process for using the apparatus 100 to carry out a method of forming the bent, folded, or beaded edge rim of the molded component according to the invention will now be described. For simplicity, the following discussion will refer only to the molded component unfinished blank 102 that is to be finished with a bent or angled-in edge rim with a single bend at about 90° (e.g. in a range from 70 to 110°) as will be discussed in detail below in connection with FIGS. 13A, 13B and 13C. Similar processing steps and operating functions of the apparatus, however, also pertain to the processing of an unfinished blank 104 that is to be finished with a double-folded or beaded edge rim having two bends, each by about 90°, as shown and described in detail below in connection with FIGS. 12A, 12B, 12C, and 12D. The second embodiment will then be discussed in detail, in further development of the first embodiment.

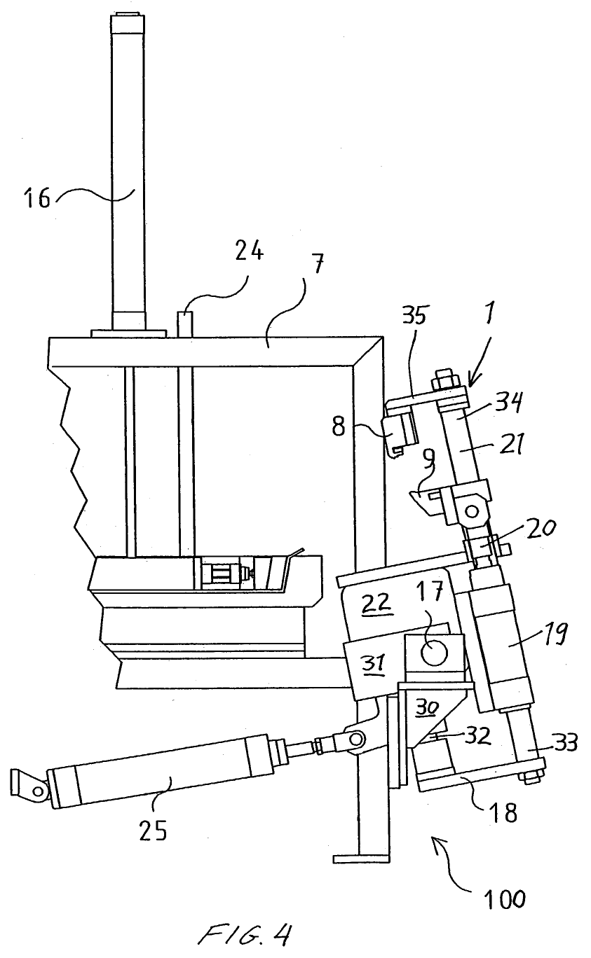

As mentioned above, the unfinished blank 102 is first positioned and fixed in the forming mold 11 by the workpiece holder 13. That is achieved by the sequence of steps shown in FIGS. 3, 4 and 5. Namely, the unfinished blank 102 is first placed in the forming mold 11, with the workpiece holder 13 raised clear, as shown in FIG. 3. Then, the vertical linear drive 16 extends its piston rod 23 to lower the carrier frame 15 and therewith the horizontal linear drive 14 as well as the workpiece holder 13 into the lowered position shown in FIG. 4. Next, the horizontal linear drive 14 is actuated to press the workpiece holder 13 laterally against a sidewall or rim 105 of the forming mold 11, with a sidewall of the unfinished blank or workpiece 102 pressed and securely held therebetween, as shown in FIG. 5. This leaves an edge rim 12 of the unfinished blank 102 protruding from between the workpiece holder 13 and the sidewall or rim 105 of the forming mold 11.

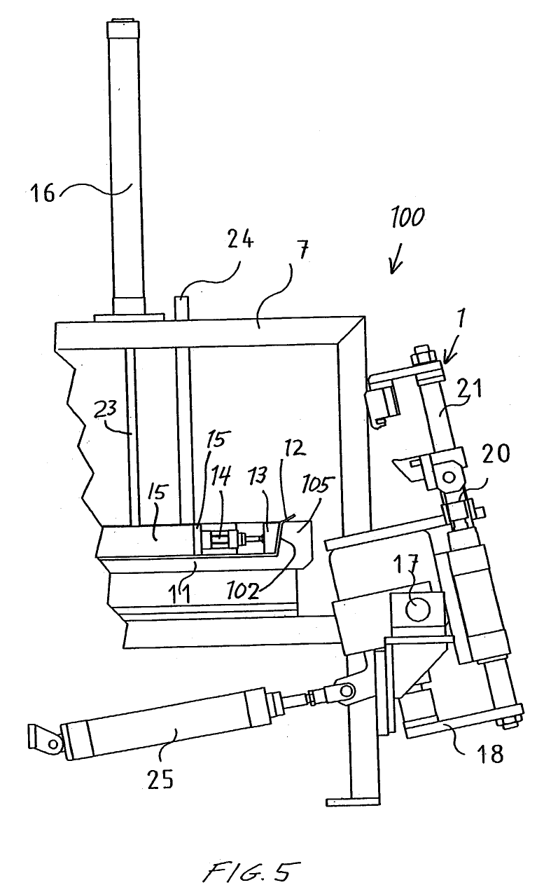

After the unfinished blank 102 has been fixed in the forming mold 11 by the workpiece holder 13 as described above, the bending unit 1 is pivoted about the pivot axis or axle 17 from the resting position shown in FIG. 5 to a working position shown in FIG. 6. In this position, the heatable impressing or stamping element 8 is located a slight distance away from and laterally inwardly above the protruding edge rim 12 or particularly the edge rim flange 101 of the unfinished blank or workpiece 102. The element 8 is heated, for example electrically by passing an electrical current through an electrical resistance heater electrode thereof. Meanwhile, the pressing or rim-bending element 9 is positioned directly outwardly adjacent to the edge rim flange 101, for example sitting on a free rim surface 122 of the rim 105 of the forming mold 11.

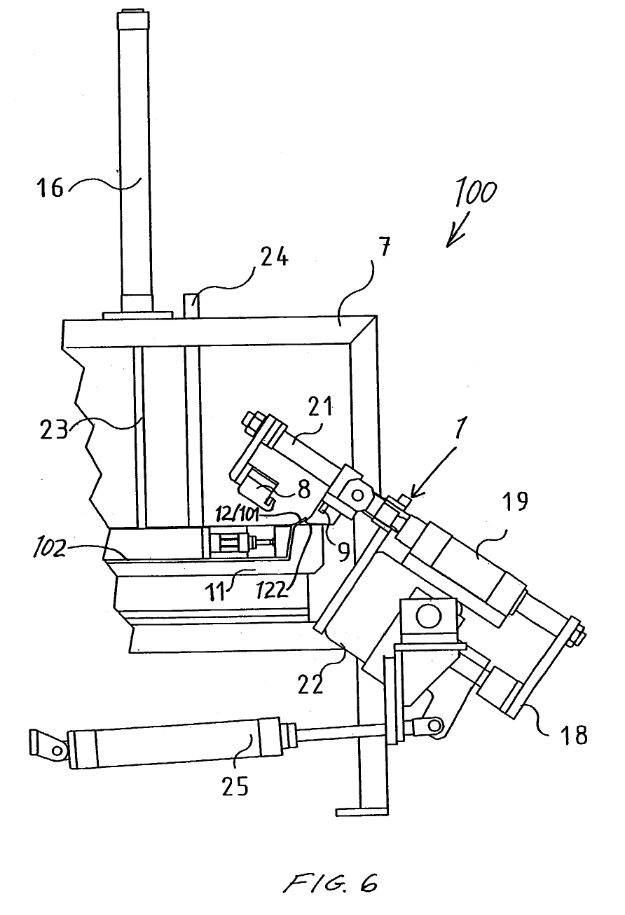

Next, the linear drive 22 is activated to move the connector element 32 in the form of a piston rod or connecting rod, the plate-shaped connecting bracket 18, and the push rods 21, as well as the spacer bracket 35, to therewith move the heated element 8 against the material 106 of the molded component unfinished blank 102, in order to form a line-shaped or channel-shaped weakened zone 107 at the desired location along the edge of the unfinished blank 102 as shown in FIGS. 7 and 13B, as will be discussed in further detail below. After formation of the weakened zone 107, the heatable element 8 is moved back into its retracted prior position corresponding to FIG. 6, as now shown in FIG. 8.

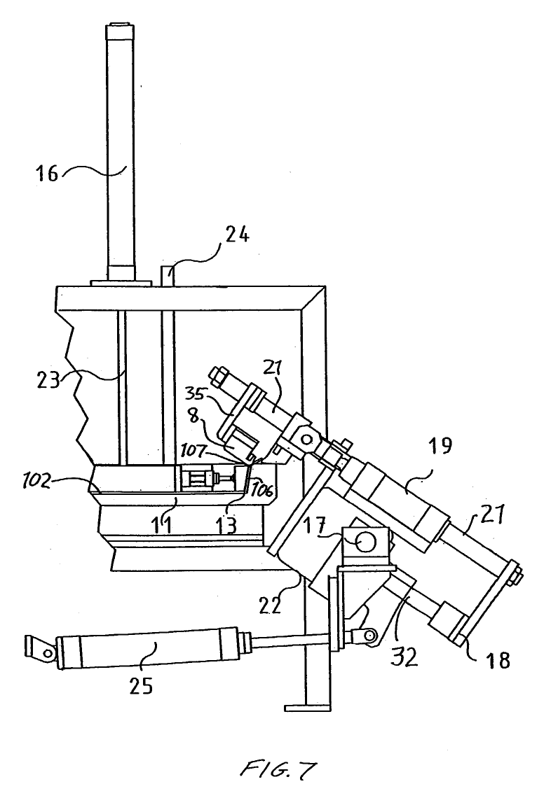

After retraction of the element 8, or simultaneously therewith, the slider-like pressing or rim-bending element 9 rests against or contacts the edge rim flange 101 as shown in FIG. 8, to now carry out its action as follows. Namely, the pressing element 9 is driven and moved via the linear drive 19 and the piston rod 20 from the position shown in FIG. 8 to the position shown in FIG. 9. It should further be understood, that the entire bending unit 1 is slightly farther pivoted about the pivot axle 17 while the pressing element 9 is extended, from the position shown in FIG. 8 to the position shown in FIG. 9. Thereby, the pressing element 9 presses against the edge rim flange 101, so as to bend the edge rim flange 101 inwardly or toward the left in FIGS. 8 and 9, about the bending line formed by the weakened zone 107, to thereby form the angled or bent rim 101′ as shown in FIG. 9. In the illustrated example embodiment, this angled or bent rim 101′ has been tipped and bent over to lie on the top surface of the workpiece holder 13. The sliding motion of the pressing element 9 has thus bent-over and then “ironed” or flattened the bent rim 101′ onto the top surface of the workpiece holder 13, while also crisply bending and flattening the bent corner formed along the bending line provided by the weakened zone 107.

Once the condition shown in FIG. 9 is reached, heat is removed from the unfinished blank 102 in the area of the bent rim 101′ and the weakened zone 107, so that the material 106 of the unfinished blank 102 again returns to its original strength and stiffness. Thereby, the edge rim flange 101 becomes permanently fixed in its angled or bent position as the angled or bent rim 101′.

Namely the heat from the heated impressing or stamping element 8 not only formed the weakened zone 107 as a bending line, but also softened and at least partially melted the material 106 around the area of the weakened zone 107, so that the material in this area would be more flexible to facilitate the bending operation along the bending line formed by the weakened zone 107, and so that the material could be reconfigured into the new bent configuration, melt-bonded onto itself in the new configuration, and then permanently fixed in the new configuration simply by removing heat therefrom. The heat removal can be achieved simply by allowing the passive cooling of the material over time, or by actively removing heat, for example by directing cool air at the pertinent location, or by cooling the workpiece holder 13 and/or the rim 105 of the forming mold 11 and/or the bending element 9 by means of a cooling fluid flowing through cooling channels 26 provided therein, or by other known cooling means. It should also be understood that the workpiece or unfinished blank 102 may be at room temperature, or may itself be preheated or still hot from its molding operation, when it is first placed into the forming mold 11.

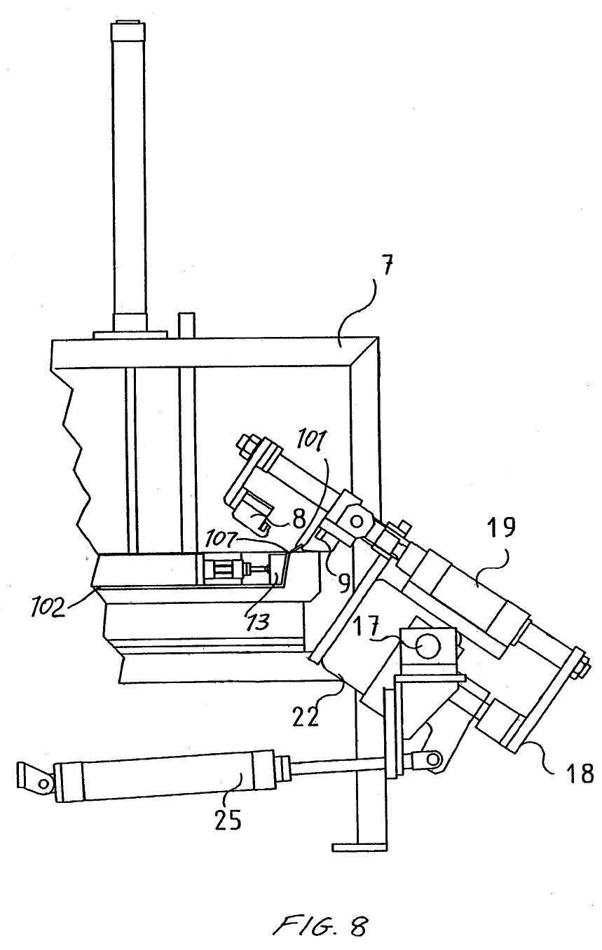

After the above steps of FIG. 9 are completed, the bending unit 1 is pivoted back into its resting position as shown in FIG. 10, so that all of the tools and machine components are clear of the unfinished blank or molded component. Next, the finished molded component 102′ is lifted out of the forming mold 11 by activating the vertical linear drive 16 to lift the workpiece holder 13, as shown in FIG. 11. Finally, by retracting the horizontal drive 14, the workpiece holder 13 is retracted so as to release the finished molded component 102′.

Further details about the edge-bending, folding or beading process as well as the machine components serving to carry out these steps, and regarding the resulting product, are shown and described in further detail in connection with FIGS. 12 to 16, as will be discussed below.

Using the heatable element or elements 8 that operate as an impressing or stamping tool as described above, first the cross-sectional dimension of the material 106 of the molded component unfinished blank 102 or 104 is reduced in an area near the edge of the unfinished blank, along a line-shaped or groove-shaped or channel-shaped weakened zone 107 (shown in FIG. 13B) or along two parallel spaced-apart line, groove, or channel-shaped weakened zones 108 and 109 (as shown in FIG. 12B), through the application of heat and sufficient pressure by the element 8. The formation of either one weakened zone 107, or two weakened zones 108 and 109, simply depends on the particular configuration of the heatable element 8, which will be selected as appropriate depending on the desired formation of a singly-bent angled or bent edge rim 101′ (FIG. 13C) or a doubly-folded edge rim 103′″ (FIG. 12D). In any event, these weakened zones 107, 108 and 109 serve first of all as bending lines, but also to form two angled or relatively wedge-positioned bounding surfaces 110 and 111 according to the first embodiment of FIGS. 13A to 13C or four of such angled or relatively wedge-positioned bounding surfaces 112 and 113 as well as 114 and 115 according to the second embodiment of FIGS. 12A to 12D.

After formation of the weakened zones 107 or 108 and 109, the edge rim flange 101 according to FIG. 13A, or the parallel adjacent edge rim portions (i.e. the free edge flange and the intermediate strip) 103′ and 103″ of the edge rim flange 103 according to FIG. 12C, are bent or folded-over by means of the pressing element 9 or 9′ acting as a bending or folding tool. Thereby, the respective adjacent bounding surfaces 110 and 111 or 112 and 113 or 114 and 115 that bound and form the respective wedge-shaped weakened zone 107 or 108 or 109 are pressed surfacially into contact with one another. Since the thermoplastic material 106 or at least the thermoplastic material component included in the material 106 has been sufficiently heated to achieve melt-adhesive characteristics, the respective paired bounding surfaces 110 and 111 or 112 and 113 or 114 and 115 that are pressed into contact with each other are thereby pairwise adhesively bonded together.

After the bending or folding and the adhesive bonding have been completed as described above, heat is withdrawn from the material 106 at least in the area of the weakened zone or bending line (or weakened zones or bending lines). Thereby, due to this cooling, the material 106 again attains its normal strength and stiffness, while also fixing the melt-adhesive bonding of the joined opposite bounding surfaces of each weakened zone. Thus, the bent rim 101′ of the finished molded component 102′ (as shown in FIG. 13C) or the folded and beaded edge rim 103′″ of the finished molded component 104′ (as shown in FIG. 12D) are fixed in the new desired position and condition, and have the necessary form stability to remain permanently in this condition.

For forming the respective weakened zones 107 (or 108 and 109), the heatable element 8 is preferably embodied as an electrically heatable impressing or stamping electrode. More particularly, the heatable element 8 comprises a cutting or stamping edge 16 that is bounded between two tapering cutting edge faces or bevel faces 117 and 118 that extend at an acute angle relative to each other. The term “cutting edge” allows for but does not require actual “cutting” in the manner of separating the material mechanically, but rather also allows for stamping or impressing a groove in connection with the heat-melting of the material. Thereby, the cutting edge faces or bevel faces 117 and 118 define the position and relative wedge angle of the resulting bounding surfaces 110 and 111 in the material 106 of the molded component unfinished blank 102. The details of the configuration of this heatable element 8 can be seen in FIGS. 13B and 14.

The cutting edge 116 along with its defining bevel faces 117 and 118 are formed on a cutting or stamping body 27, and extend either substantially linearly or, if required, along a spatial curve corresponding to the desired curved contour and shape of the edge of the molded component 102′ that is to be produced. Generally, the heatable element 8 has an L-shaped cross-section (see FIGS. 13B and 14). Thereby, the element 8 has a short shank 119 with the cutting edge 116 on the free end thereof, as well as a long shank 120, and a holding or mounting piece 121 that extends from the short shank 119 parallel to the long shank 120. A heating element, for example in the form of an electrical resistance heating element, is arranged on the heatable element 8, for example between the long shank 120 and the holding or mounting piece 121, in order to heat the impressing electrode or element 8 to an exactly defined degree. Although the heating element itself is not particularly illustrated, it can have any conventionally known form and arrangement of a heating element, along with any required control element such as a temperature sensor. The respective required temperature depends on the type of the material 106 that is to be processed, and generally lies in the range between 160° C. and 300° C.

While forming the weakened zone 107, the sidewall of the molded component unfinished blank 102 is supported against the sidewall 105 of the forming mold 11, which thus acts as a countertool or countersupport for the heatable element 8. In this condition, the edge rim 101 of the unfinished blank 102 protrudes over a free rim surface 122 of the rim 105 of the sidewall of the forming mold 11, as shown in FIG. 13A. FIG. 13B then shows the detailed operation of the heatable element 8 to form the weakened zone 107, which lies approximately on the plane of the surface 122.

Next, as shown in FIG. 13C, the pressing element 9 embodied as a slider is slidably movable along the surface 122 in a direction perpendicular to the edge rim 101 and the weakened zone 107. For this purpose, the pressing element 9 comprises a sliding surface 123 that lies and slides on the free rim surface 122 of the forming mold 11, as well as a pressing nose 124 on one edge thereof. The sliding surface 123 transitions in a smooth curve or arc through the pressing nose 124 into a nose surface or second surface 125 that extends at an acute angle relative to the sliding surface 123. Note that FIGS. 13A, 13B, and 13C thus merely illustrate, on an enlarged scale, further details of the apparatus and method as described above in connection with FIGS. 6 to 9.

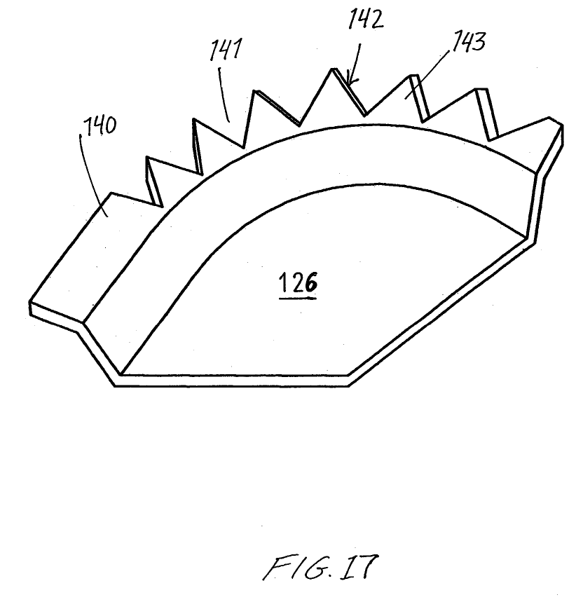

Also, in the particular example embodiment of the configuration of a pressing element 9″ shown in FIG. 16, the pressing nose 124″ of this pressing element 9″ is slightly elevated or raised relative to the sliding surface 123″. This can involve slightly rounding or beveling the forward portion of the sliding surface 123″ adjoining the pressing nose 124″, for example.

Upon sliding the pressing element 9 or 9″ from the position shown in FIGS. 13A and 13B into the position shown in FIG. 13C, the free edge rim 101 is bent or angled in the direction of motion of the pressing element 9 about the weakened zone 107 that acts as a bending line. Thereby, the bounding surfaces 110 and 111 of the weakened zone 107 are pressed into contact with one another as shown in FIGS. 13C, and become melt-bonded or welded together with each other.

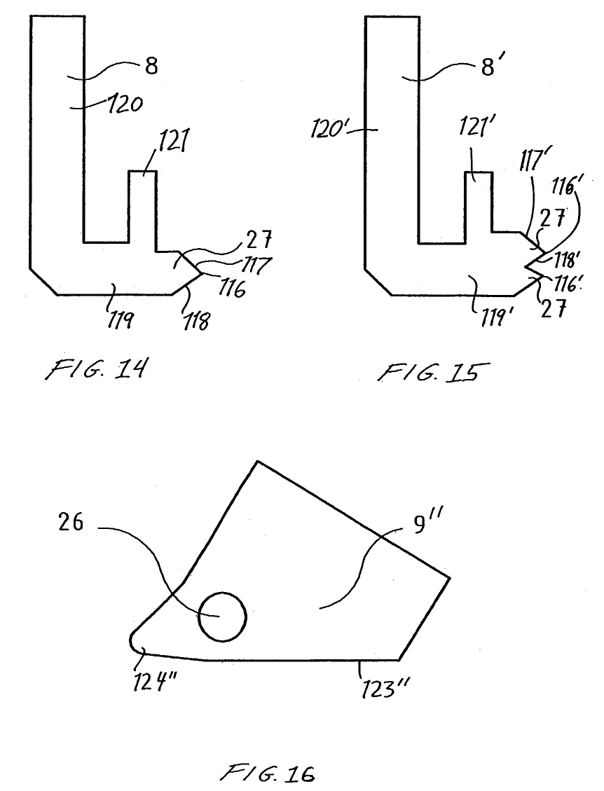

In order to form two parallel weakened zones 108 and 109 according to the second example embodiment of FIGS. 12A to 12D, the heatable element 8′ (e.g. FIG. 15) comprises two respective cutter body portions 27 with two parallel arranged cutting edges 116′ that are each respectively bounded by two beveled faces 117′ and 118′. All other features of the heatable element 8′ according to FIG. 15 correspond to those of the heatable element 8 according to FIG. 14, for example including the cross-sectionally shorter shank 119′, the cross-sectionally longer shank 120′, and the holding or mounting piece 121′ for an electrical resistance heating element.

The pressing or rim-folding element 9′ as shown in FIGS. 12A to 12D, for use in connection with the heatable element 8′, is specially configured for achieving a double-fold beaded rim. Particularly, this pressing element 9′ comprises two sliding surfaces 131′ and 132′ at different levels and offset relative to each other by an offset 29 that forms a downwardly protruding hook or pressing claw 28 of the pressing element 9′, which in turn comprises two opposite pressing noses 133′ and 134′. More particularly, the sliding surface 131′ interconnects the first pressing nose 133′ that faces toward the front in the forward pressing or extension direction of the slidable pressing element 9′, and the other pressing nose 134′ facing toward the rear in the rearward retraction direction of the pressing element 9′. The two pressing noses 133′ and 134′ are bounded on the one hand by the sliding surface 131′, and on the other hand by the front surface 121′ and a rear surface 135′, which transitions into the sliding surface 132′. These two pressing noses 133′ and 134′ are used to form the two folds of the double-folded or beaded edge rim 103′″ as will be described next.

Note that FIGS. 12A to 12D and 13A to 13C also show the channels 26 provided in the pressing element 9 and 9′ as well as in the upper rim of the forming mold 11, whereby these channels or passages 26 can be used to flow a tempering liquid, and particularly a cooling liquid through the respective components 9, 9′ and 11, for removing heat from the folded rim area of the unfinished blank once the bending or folding of the rim has been carried out.

The special process for double-folding or beading the rim area of the molded component unfinished blank 104 that has been provided with two parallel spaced-apart weakened zones 108 and 109 will now be described in detail with reference to FIGS. 12A to 12D. This process is carried out using the special pressing element 9′. First, as shown in FIGS. 12A and 12B, the pressing element 9′ slides with its sliding surface 131′ on the free upper rim or edge surface 122 of the mold 11, toward the left in a direction A. Simultaneously or previously, the heatable impressing or stamping element 8′ with the two cutting edges 116′ is used to press the two weakened zones 108 and 109 into the material 106 of the unfinished blank 104, as shown in FIG. 12B. While FIG. 12B shows the outer or forward pressing nose 133′ and the associated surface 125′ spaced away from the edge rim flange 103, the element 9′ may be further advanced to contact flushly against the edge rim flange 103, so that the element 9′ acts as a countertool for the impressing or stamping operation of the element 8′.

As shown further in FIG. 12C, the sliding movement of the pressing element 9′ in the direction A serves to bend the edge rim flange 103, with its two edge rim portions 103′ and 103″ (bounded by the weakened zones 108 and 109) toward the left in a bent or angled position as shown in FIG. 12C. Then, as soon as the element 9′ has moved in the direction A far enough so that the rear or inner pressing nose 134′ extends beyond the second weakened zone 108, then the pressing element 9′ is moved in the direction B perpendicularly to the direction A, as shown in FIG. 12C and particularly in the transition from FIG. 12C to FIG. 12D. Thereby, the pressing nose 134′ pushes the edge rim portion 103′ at the free edge of the unfinished blank 104 downwardly to achieve a double-folded or reverse-beaded configuration of the edge rim.

Then the pressing element 9′ is moved in a third working direction C that is parallel to, but oppositely directed relative to the first working direction A, while it slides with its sliding surface 132′ back along the free edge surface 122 of the rim 105 of the forming mold 11. Thereby, the edge rim portion 103′ is pressed against the edge rim portion 103″, and the respective bounding surfaces of the two weakened zones 108 and 109 are pressed respectively together and are thereby melt-bonded or welded to each other due to the melt-adhesive characteristics of the previously heated material. This serves to bring the portions of the edge rim flange into exact positional contact with each other, and then a subsequent cooling serves to permanently fix the portions in a bonded condition with this configuration. As mentioned above, the cooling can be achieved actively by flowing a cooling medium such as cool water through cooling channels 26 in the pressing elements 9 and 9′ as well as in the sidewall or rim 105 of the mold 11.

The motions or working strokes of the pressing element 9′ according to the arrows A, B and C require only very small stroke motions of the drives 19, 22 and 25. More particularly, the working stroke or motion according to the arrow B is achieved by a small pivoting motion of the bending unit 1 about the pivot axle 17 in a counterclockwise direction as shown in the present drawing figures.

The unfinished blank 102 or 104 for the molded component is preferably a semi-finished blank that has been previously laminated and molded into the required three-dimensional contour of the finished molded component that is to produced, so that merely the edge rim bending or folding process still needs to be carried out to finish the molded component. Alternatively, the unfinished blank 102 or 104 may start as a raw material blank that is first subjected to the edge folding or bending process, and thereafter to the final molding process for achieving the finished molded contour of the molded component.

In any event, the unfinished blank 102 or 104 preferably comprises a multi-layered laminated structure, for example including a backing layer 106 as well as a support or carrier layer 128 that serves as a sheathing. For example, the unfinished blank 102 or 104 can include a substrate layer, a foam backing layer, and a decorative cover stock sheet layer. Especially the material 106 of the backing layer includes a thermoplastic polymer component, so that it can be thermoplastically formed and processed under the influence of heat and pressure, and so that it exhibits melt-adhesive characteristics when it is heated to a sufficient partial-melting or tack-adhesion temperature. The weakened zones 107, 108 and 109 preferably penetrate into and entirely through the thickness of the backing material 106 until reaching or partially penetrating into the thickness of the carrier layer 128 (see FIG. 12A, FIG. 13A, and FIG. 13C). The carrier layer 128 also includes a thermoplastic polymer, and its cross-sectional thickness is preferably provided at least with a partial weakened zone. To achieve such a weakened zone penetrating not only through the backing material 106, but also into the carrier layer 128, the cutting edges 116 or 116′ of the heatable element 8 are simply driven with the respective required separating or stamp-cutting pressure, while also accurately controlling the motion, i.e. the precise travel distance of each working stroke of the associated drives.

The unfinished blank as well as the finished molded component can have essentially any desired rim shape or contour, whereby it is simply necessary to provide the appropriate combination of tools 8 and 9 having the proper contour shapes. For example, as shown in FIG. 17, the edge rim flange 140 of a molded component unfinished blank 126 can have a curved or arcuate shape. In such a case, the edge rim flange 140 is first provided with cut-out notches 141 before the edge-bending or edge-folding step, so that the edge rim 142 that is to be processed is actually made up of a plurality of individual protrusions 143 between the successive notches 141. Suitably, the notches 141 and the protrusions 143 may each be substantially triangular in plan shape. Alternatively, the notches 141 and/or the protrusions 143 could have a trapezoidal shape or the like. This notched contour ensures that the material of the edge rim can be bent inwardly or folded back upon itself, even along the curved contour, without bunching or crumpling the material.

FIG. 1 shows such curved or arcuate body edges 127 forming the contour of corner portions of a molded component unfinished blank 126 in the area of the two bending units 1 and 5. In order to process such a curved or arcuate edge rim, the respective bending units 1 and 5 are equipped with similarly curved heatable elements 8 and pressing elements 9.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method of forming a rim of a self-supporting thin-walled molded component, comprising the steps:
a) providing an unfinished blank that is to be finished to form said molded component;
b) forming in said blank a first weakened zone adjacent to and along an edge of said blank by at least one step including applying heat to said blank so as to reduce a cross-sectional thickness of said blank along said first weakened zone, and thereby defining a free edge flange of said blank extending along and between said first weakened zone and said edge of said blank;
c) bending said free edge flange into a first bent position relative to a remainder of said blank along said first weakened zone which provides a first bending hinge; and
d) fixing said free edge flange in said first bent position, comprising removing heat from said first weakened zone;
wherein said rim comprises said free edge flange fixed in said first bent position.

2. The method according to claim 1, wherein said step a) of providing said unfinished blank comprises pre-molding a raw blank to form said unfinished blank having a main blank body with a multi-dimensionally molded contour as required by said molded component.

3. The method according to claim 1, wherein said unfinished blank provided in said step a) is a multi-layered laminated blank comprising a thermoplastic synthetic material.

4. The method according to claim 3, wherein said multi-layered laminated blank comprises a backing layer and a visually decorative cover stock layer, and wherein said first weakened zone is formed at least in a cross-sectional thickness of said backing layer.

5. The method according to claim 3, wherein said multi-layered laminated blank comprises a first layer and a carrier layer, and wherein said first weakened zone penetrates entirely through a cross-sectional thickness of said first layer and partially into a cross-sectional thickness of said carrier layer.

6. The method according to claim 1, wherein said molded component is a hot-molded interior trim component for a motor vehicle.

7. The method according to claim 1, wherein said first weakened zone is a narrow stripe-shaped zone extending along a straight or curved line.

8. The method according to claim 1, wherein said removing of heat in said step d) comprises passive ambient cooling.

9. The method according to claim 1, wherein said bending in said step c) is performed using a bending tool cooperating with a forming mold, and wherein said removing of heat in said step d) comprises actively cooling at least one of said bending tool and said forming mold by flowing a cooling fluid through a cooling passage therein.

10. The method according to claim 1, further comprising the steps:
e) forming in said blank a second weakened zone adjacent to and along said first weakened zone by at least one step including applying heat to said blank so as to reduce a cross-sectional thickness of said blank along said second weakened zone, and thereby defining an intermediate strip of said blank extending along and between said first weakened zone and said second weakened zone;
f) bending said intermediate strip into a second bent position relative to a remainder of said blank along said second weakened zone which provides a second bending hinge; and
g) fixing said intermediate strip in said second bent position, comprising removing heat from said second weakened zone;
wherein said rim further comprises said intermediate strip fixed in said second bent position.

11. The method according to claim 10, wherein said step e) is carried out simultaneously with said step b).

12. The method according to claim 10, wherein said step f) is carried out before said step c).

13. The method according to claim 10, wherein said step f) comprises forming a bend of approximately 90° about said second bending hinge between said intermediate strip and a rim portion of said remainder of said blank adjoining said second weakened zone opposite said intermediate strip, and said step c) comprises forming a bend of approximately 90° about said first bending hinge between said free edge flange and said intermediate strip so that said free edge flange extends parallel to said rim portion of said remainder of said blank.

14. The method according to claim 10, wherein said steps c) and f) are carried out using a pressing slider tool, by first moving said tool in a first direction, then moving said tool in a second direction perpendicular to said first direction, and then moving said tool in a third direction opposite and parallel to said first direction.

15. The method according to claim 1, wherein said steps c) and d) complete said rim, which includes only said first weakened zone and said free edge flange fixed in said first bent position relative to said remainder of said blank.

16. The method according to claim 1, wherein said reducing of said cross-sectional thickness comprises locally removing material of said blank.

17. The method according to claim 1, wherein said reducing of said cross-sectional thickness comprises locally melting-away material of said blank.

18. The method according to claim 1, wherein said reducing of said cross-sectional thickness comprises locally displacing material of said blank.

19. The method according to claim 1, wherein said reducing of said cross-sectional thickness comprises locally compressing or densifying material of said blank.

20. The method according to claim 1, wherein said at least one step to reduce said cross-sectional thickness further comprises applying pressure to said blank in addition to applying said heat to said blank.

21. The method according to claim 20, wherein said pressure is sufficient to at least partially cut or separate a material of said blank.

22. The method according to claim 1, wherein said reducing of said cross-sectional thickness forms said first weakened zone as a groove having an open triangular cross-sectional shape in said blank.

23. The method according to claim 22, wherein said fixing of said free edge flange in said first bent position further comprises at least partially melting a material of said blank along sidewalls bounding said groove, pressing together and melt-bonding together said sidewalls of said groove, and then said removing of said heat from said sidewalls of said groove.

24. An apparatus for forming a rim of a self-supporting thin-walled molded component, comprising:
a forming mold that includes a mold rim and that is adapted to receive an unfinished blank that is to be finished to form the molded component;
a workpiece holder that is movably arranged relative to said forming mold and that is adapted to clampingly hold the unfinished blank in or on said forming mold;
a heatable stamping tool that is movably arranged relative to said forming mold and that is adapted to heat and stamp the unfinished blank to form at least one groove-shaped weakened zone therein adjacent to and along an edge thereof; and
a pressing tool that is movably arranged relative to said forming mold and that is adapted to bend a portion of the unfinished blank about the at least one weakened zone.

25. The apparatus according to claim 24, wherein said heatable stamping tool is an electrically heatable impressing tool including an electrical heating element.

26. The apparatus according to claim 24, wherein said heatable stamping tool includes at least one cutting or impressing blade bounded by two blade faces that intersect each other along a blade edge at an acute angle in cross-section.

27. The apparatus according to claim 26, wherein said heatable stamping tool includes two of said cutting or impressing blades spaced apart from each other.

28. The apparatus according to claim 26, further comprising a stamping drive connected to said stamping tool and adapted to apply a stamp-cutting pressure to said stamping tool for at least partially cutting the unfinished blank along the weakened zone.

29. The apparatus according to claim 26, wherein said stamping tool has an L-shaped cross-section including a longer leg and a shorter leg, wherein said at least one cutting or impressing blade is provided at an end of said shorter leg.

30. The apparatus according to claim 24, wherein said pressing tool comprises a first sliding surface, a front nose surface extending at an acute angle relative to said first sliding surface, and a curved edge arcuately transitioning from said front nose surface to said first sliding surface, and wherein said pressing tool is arranged to be slidable with said first sliding surface along an edge surface of said mold rim of said forming mold.

31. The apparatus according to claim 30, wherein said curved edge is a first pressing nose located and arranged to press against and bend the portion of the unfinished blank.

32. The apparatus according to claim 31, wherein said pressing tool further comprises a second sliding surface parallel to and offset from said first sliding surface, a rear nose surface interposed and extending between said first and second sliding surfaces, and a second pressing nose arcuately transitioning from said first sliding surface to said rear nose surface.

33. The apparatus according to claim 32, wherein said pressing tool is arranged to be slidable along at least two perpendicular axes, and further comprising a pressing drive arrangement connected to said pressing tool and adapted to slide said pressing tool sequentially in a first direction, then in a second direction perpendicular to said first direction, and then in a third direction opposite and parallel to said first direction.

34. The apparatus according to claim 24, further comprising a pressing drive connected to said pressing tool and a stamping drive connected to said stamping tool, and wherein said stamping tool, said pressing tool, said stamping drive and said pressing drive are assembled together to form a respective rim bending unit cooperating with said forming mold and said workpiece holder.

35. A self-supporting thin-walled molded component comprising a molded component body and a formed rim at an edge of said body, wherein said component includes a thermoplastic synthetic material that exhibits thermoplastic adhesive bonding properties when heated to a sufficient temperature, and said formed rim includes a first rim portion that is bent relative to said body and connected to said body through a first weakened zone including a first closed groove of which opposite bounding surfaces have been pressed and thermoplastically melt-bonded together.

36. The molded component according to claim 35, wherein said formed rim further includes a second rim portion that is bent relative to said first rim portion and connected to said first rim portion through a second weakened zone including a second closed groove of which opposite bounding surfaces have been pressed and thermoplastically melt-bonded together.
